(19) United States
(12) Patent Application Publication
(10) Pub. No.: US 2008/0020729 A1
(43) Pub. Date: Jan. 24, 2008

(54) Cell phone directory, selection, and billing method

(76) Inventors: Daniel Bernal, Costa Mesa, CA (US); Jason Berry, Irvine, CA (US)

Correspondence Address: PATENT LAW & VENTURE GROUP, 2424 S.E. BRISTOL, SUITE 300, NEWPORT BEACH, CA, 92660, US

(21) Appl. No.: 11/492,488

(22) Filed: Jul. 24, 2006

(51) Int. Cl. H04M 11/00

(52) U.S. Cl. 455/406

(57) ABSTRACT

An internet accessible server operates with a large database of places that provide goods and/or services. When a cell phone user finds need for a product or service, a user application stored in the phone is operated to display and then select a category heading from a list stored in memory, and upon selection, a cell connection is made via data transmission to the server. The server responds by sending to the phone, a list of the places within its database that are in the category and location selected by the phone user. When the user then selects one of the places, the server provides an enable signal and the cell phone is then able to display and dial the associated phone number. Billing to the selected place is then made based on the marketing service provided.

### BACKGROUND OF THE INVENTION

1. Field of the Present Disclosure

This disclosure relates generally to directory assistance to those seeking products or services, and more particularly to a cell phone directory service capable of identifying to the cell phone user, a list of places offering a good or service sought in exchange for payment by the place identified to the user.

2. Description of Related Art Including Information Disclosed Under 37 CFR 1.97 and 1.98

Handel et al., U.S. 2002/0035501, discloses a system that facilitates creation of a web-based user interface which obtains user profile information from a database, gathers information from one or more users regarding product characteristics, correlates the user responses, performs statistical analysis of the user responses and presents the statistical analysis in a user comprehendible manner. The system also stores statistical ratings in a database correlated to a particular product or service. Ratings are provided to a user from the database based on a particular product or service, and the database can be queried to retrieve one or more user profiles that have rated a product of interest to the current use.

Chan et al., U.S. 2002/0068585, discloses a system and method to automatically search the required local information for the information user. It can use the information user's personal profile, position history, and query history to generate the next set of information user's required local information. The information search list can also be generated based on the information user profile. This local information accessing system and method will be very useful if the information user is mobile and do not have enough time to search the web.

Case et al., U.S. 2002/0126819, discloses an automated business directory assistance that routes a call for directory assistance to a speech recognizer which determines the type of assistance requested. If the request is for business information, the requested information is automatically retrieved. Otherwise, the call is routed to a call center.

Fridman, U.S. 2004/0117225, discloses a method and system for enabling a user or consumer to, through a wireless device including an identification code associated with the device, receive consumer-oriented materials from a desired business establishment. The method comprises the steps of, associating a server operable to receive and send messages with the desired business establishment, the server identified by at least one business identification number (BID), wherein the server is responsive to a first BID entered by the user on the wireless device for identifying the user by the user identification code and transmitting at least one message containing the user identification code and information associated with the desired business establishment to the user, and is further responsive to a second BID entered by the user on the wireless device and identifying the user by the user identification code to terminate the transmission to the user, whereby the receipt and termination of information from the server is solely under the control of the user.

Perkins et al., U.S. 2004/0204958, discloses a system and method that provides electronic registration and maintenance of business directory listings and advertisements. In a computer system hosting an online business directory, it is advantageous to provide interested businesses with the ability to register their business listing information and/or advertisements such that the user may have direct input into the categorization the business listing(s) or advertisement(s) in the business directory. In an illustrative implementation, the system and methods of the present invention may be realized as an Internet based registration computing application cooperating with a business directory storing and displaying business directory listing information. This registration computing application may be employed as part of an Internet business directory listing information offering deployed on a Web site that offers business listing information services. The registration computing application may comprise a user interface to accept business listings and advertisement information from participating businesses, and instruction sets directed to the storage, maintenance, and modification of this information in a cooperating business directory listing data store.

Ramirez et al, U.S. 2005/0159137, discloses a method to enable the customer to access residential, business or government directory information on a city, state or federal level from a cell phone. The customer will select the directory option from the main menu listing. Then the customer will select one of the following submenus: local or national. The next step will be for the customer to select one of the following: residential, business or government. The customer will then have the option to enter one of the following: last name, business name, business category, or the first letter the specific option the customer is searching for. This will provide the customer with an alphabetical list under the entered request. When available the address will also be provided. Auto dial and save functions will be available. In order to do this the customer will need to spell out their request by pressing the number 2 for the letter A, B or C; number 3 for the letters D, E or F etc. A yearly download will be required to have an up to date listing.

Agarwal et al., 2005/0216341, discloses a method of connecting telephone calls and track information about the telephone calls resulting from advertisements on mobile/wireless media channels. In one embodiment, a method includes: assigning a telephone number to an advertiser, one of the telephone number and a reference to the telephone number to be included in an advertisement provided to an end user via a wireless media; and, monitoring telephone connections to the telephone number to bill the advertiser for the advertisement in response to each telephone connection to the telephone number. In one embodiment, a method includes: a first party providing an advertisement to a mobile device on behalf of an advertiser, the advertisement to include at least a reference to a telephonic connection with the advertiser; and, the first party collecting a fee from the advertiser in response to a telephonic connection being established between the advertiser and customer.

Bednarek, U.S. 2005/0251440 and U.S. Pat. No. 6,965,868, disclose a personal communication and electronic commerce system for use by participating users and participating merchants in connection with incentive programs in the Network Economy. The system includes a cellular communication network that includes geographically spaced base stations that are linked to a fixed communication network. Users may have personal communication devices that can be used to allow a digital message generated on the personal communication devices by placing a call through one of the base stations and memory for storing a digital value corresponding to a monetary value. The personal communication device may also be used as a cellular position locator to determine one's geographic location and, if desired, to access information from a merchant information database containing information pertaining to a plurality of participating merchants located within the geographic territory covered by the cellular communication network. The merchant information may be stored on a database that is accessible by merchants so those merchants can add, delete or alter information contained in their respective listings. An incentive system is also provided for creating incentives for participating users to encourage. This computer implemented incentive program for encouraging certain participant actions includes a first reward program under which participants may earn points for certain actions and a second reward program through which the redemption rate associated with a particular participant is adjusted in response to certain participant action. The incentive program has a wide range of applications, including transportation, financial services and computer gaming.

Klemow, U.S. 2005/0044061, discloses an approach for providing an electronic business directory (e.g., Digital Yellow Pages) with interactive services over an electronic consumer device. The device includes means for retrieving information from a remote database storing business directory listings and advertisements, wherein the remote database is accessed over a data network (e.g., the global Internet) and is capable of being modified directly by a business listed in the directory or by an agent of the business. According to one embodiment of the present invention, the device also includes a touch screen display for displaying the information and for receiving input relating to the retrieved information associated with the interactive services.

Van Zandt, U.S. 2006/0010046, discloses methods and apparatuses for providing the location of consumer products. A designation for a particular product or class of products is received from a consumer via a digital processing system. The consumer is automatically provided with the location of the product in relation to a specific location.

Ogasawara, U.S. Pat. No. 6,975,856, discloses an electronic shopping system that facilitates purchase transactions via a wireless telephone. A purchase transaction program is downloaded from the seller's server to a purchaser's wireless telephone via a program loader contained within the purchaser's wireless telephone. The purchase transaction program is stored in a program memory of the purchaser's wireless telephone. The purchase transaction program is used by the purchaser to facilitate the selection of items to be purchased, as well as payment therefore. An external bar code reader is attached to the wireless telephone to facilitate the selection of items to be purchased and is controlled via the downloaded purchase transaction program.

The related art described above discloses wireless communication systems including those used for directory assistance in finding telephone numbers of known places and those facilitated for reviewing a list of local places with and without benefit of a grading method. However, the prior art fails to disclose such a system that provides for interaction between a cell phone with a host server via Internet connection whereby a hierarchical list of subjects is held resident within the cell phone and which after selection of a subject (commercial establishment) communication with an extensive database of actual places related to the subject are presented to the cell phone from the server for selection and connection via cell network. Cost/payment accounting associated with each selection is then completed. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

It is very clear that the finding of convenient and appropriate products and services is an important function in society. The yellow pages of printed phone directories are ubiquitous and have established common usage for those seeking products and services, yet cell phone users are not likely to have access to them. Likewise, similar directories have more recently been made available via the Internet; directories such as Google and Yahoo, and these are available to cell phone users. Yet such Internet directories are limited to those with Internet access and are not particularly convenient to the cell phone user because of the manner in which they operate and display. A convenient directory service is not available to the cell phone user primarily because of limitations on memory storage capacity in today's cell phone and also because a system for presenting such information in a compact and convenient form has not been found. Also, such a convenient and useful directory system must be funded and no scheme for such funding exists. However, the present invention method overcomes these limitations and restrictions to provide a highly convenient, fast and effective means for enabling cell phone users to chose those industrial and commercial places that meet their instant needs. The present invention, too, provides for a fair and effective, novel, manner for the funding of such services. In the present method, cell phone users are provided, resident within their phones, an extensive list of subjects related to the services and products offered within society in general. An internet accessible server operates with a large database of actual places that provide the products and services in the cell phone lists. When a cell phone user finds need for a product or service, the user application stored in the phone is operated to display and then select a category from the list and upon selection, a cell connection is made via data transmission to the server. The server responds by sending to the phone, a list of the places within its database that are in the category selected by the phone user. When the user then selects one of the places, the server provides an enable signal and the cell phone dials the selected place, and the place is billed a marketing fee.

A primary objective inherent in the above described method of use is to provide advantages not taught by the prior art.

Another objective is to provide a method of more conveniently gaining instant telephone access to a large directory of product and service providers through the use of the cell phone network and without charge to the cell phone user.

A further objective is to provide such a method that is billed to those providing the services and products on a pay-per-call basis.

A still further objective is to provide such a method that is able to provide vendor choices within a selected geographical area or other demographic limitation.

A still further objective is to provide such a method that, by default, recognizes a current location of the cell phone and automatically selects this current location as the chosen geographical area within which to offer places related to the cell users selection.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a block diagram of a communication network capable of carrying out the present method; and

FIG. 2 is a portion of a list of subjects that may be the interest of a cell phone user, the list stored within the cell phone for instant inquiry.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

Described now in detail is a method of providing directory services to user of wireless communication devices and in particular users of cell phones.

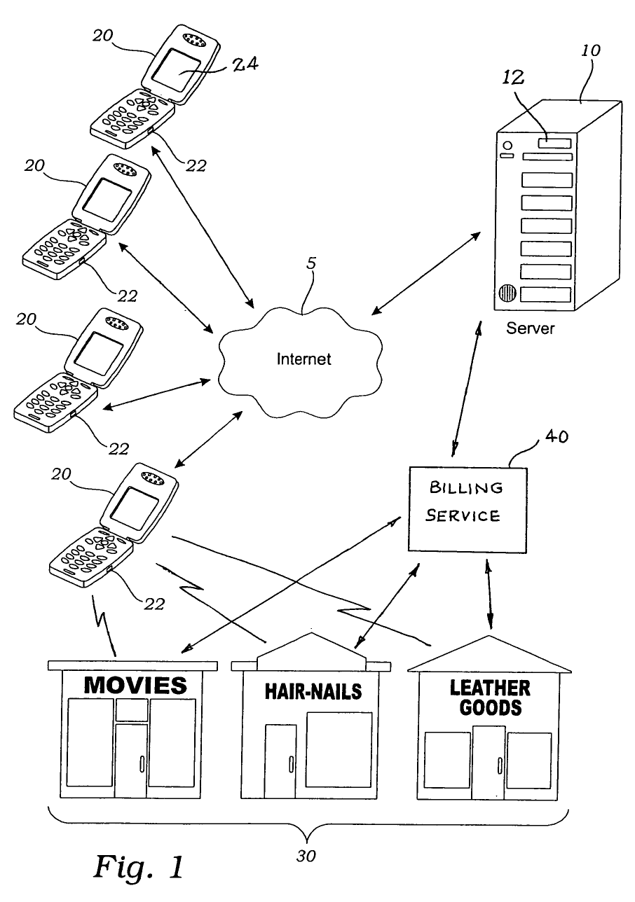

The present method comprises a series of steps in a communication network between a server 10, cell phones of users shown as element 20, and providers of goods and service, shown collectively as element 30 in FIG. 1 and referred to herein as “places.” Communications are also established with a billing service shown as element 40. The server 10 shown in FIG. 1 represents the composite of a client application server, a database server, a web server, an SMS gateway and an SMTP server, all of which all of which are referred to herein simply as server 10. This communication network is capable of carrying out the present method to accomplish the above described objectives.

In the present method, certain preliminary steps are accomplished in establishing a basis for still further steps which are carried out during routine ongoing operation of the instant method. First, a hierarchical directory of industrial and commercial subject headings is established as a first digital database (the directory) which is stored within a first non-volatile memory device 22 within the cell phone 20. To effectively use the present method, the cell phone 20 gains access to the server 10 through the well known public cell phone network and thereby to the Internet 5. This is shown in FIG. 1. It should be realized that the present method may be carried out using any wide area network or local area network, but the preferred embodiment of the present method uses the Internet 5 so as to achieve the widest range of coverage as well as the largest geographical scope. In further discussion below, the term “Internet” is used as an example only and herein represents any digital communications accessible network.

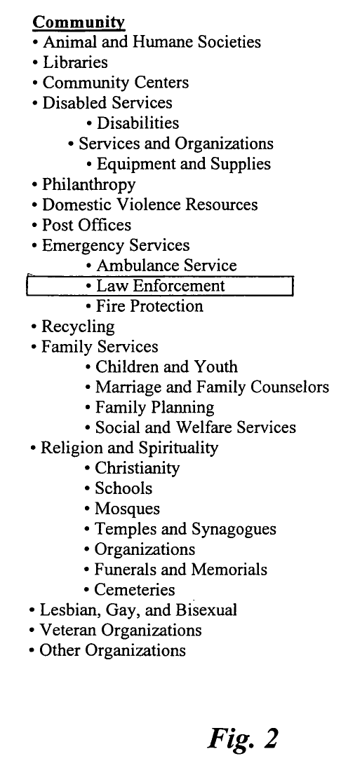

As an example, the directory preferably includes the following first level headings: Automotive, Community, Computer & Internet, Education & Instruction, Entertainment and Arts, Food & Dining, Health & Medical, Home & Garden, Legal and Financial, Other Professional Services, Personal Care, Real Estate, Recreation and Sports, Retail Shopping, Travel and Transportation, Business Services, Finance and Investment, Communications and Media, Food and Agriculture, Computers and Electronics, Government and Law, Construction and Real Estate, Health and Medicine, Conventions and Trade Shows, Manufacturing and Industrial Supplies, Education and Training, Science and Technology, Energy and Mining, Shipping and Transportation, and Entertainment and Recreation. The phone user therefore, first selects from this first level of headings and thereafter to subsequent sub-headings, etc., drilling-down to a final selection. The foregoing is only one possible manner of presenting heading to chose from as such may be alternately described, arrange and organized to meet the objectives of each user. Such a directory of subjects is generally small enough in size to fit limitations of the memory device 22 in the current cell phone technology. To navigate this directory of subject headings, as a first step, the user selects the heading of choice. If the heading of choice is “Community,” for example, a further hierarchical listing of sub-headings and sub-sub-headings within the directory is presented for scrolling and selecting. Such a listing appears on the user's cell phone screen 24 as shown in FIG. 2 and is fully visible by scrolling through the listing.

A further preliminary step is to establish a comprehensive listing of industrial and commercial places 30, i.e., places offering goods and/or services, as a second digital database (list) stored within a second non-volatile memory device 12 within, or in communication with the Internet accessible server 10. This list includes at least the name, address and telephone number for each of the places 30, and further may include:

(a) a GPS reckoned location or other coordinate reconcilable position, (b) a quality grade, (c) a price range, and other distinguishing information. In FIG. 1 several retail type commercial places 30 are shown, however, the list of industrial and commercial places may alternately include only commercial places, only industrial places, places related to only one industry or to a selection of related industries, and so on, as the users of the system warrant. It also should be realized that the list may encompass and/or be limited to geographical limitations such as: city, state, region, and country. As a common example, should I be traveling to New York from London and decide that I want to make a reservation for lodging in midtown Manhattan, I can effectively seek and find a selection of hotels in my price range and make a reservation from my cell phone while traveling to Heathrow to take my flight. The present method is highly useful.

Once these two essential preliminary steps have been accomplished, the system is ready for routine operations as described below.

In the preferred embodiment, when the cell phone 20 is not already enabled with the present client application, it may be downloaded to the cell phone by any one of several well known methods such as via cell phone connection, upload from a personal computer using a proximity transmission method such as Blackberry or Palm protocols, or using a voice transmission protocol. The client application is enabled for key word searching as is well known in the art, and alternately, the user may search through the hierarchical category list stored in cell phone memory 22. An SMS containing an encrypted or partially encrypted text string is sent from the phone 20 to the phone network carrier's SMS gateway. The gateway converts SMS to SMTP and forwards it to a mailbox on the server 10. The SMTP is decrypted into a database query issued against the server database 12. The query may be limited by: subject, geographical coordinates, geographical description, zip code, county, State or country, a quality rating, date of establishment, number of selections wanted, geographical area, ethnic orientation and by a chosen radial distance from a current or other specified location. Clearly, other possible limitations on the query are possible and the foregoing list is not meant to limit the possibilities. Clearly, combinations of the limitations are also possible and highly desirable, such as, “French restaurants within a five mile radius of the current location, that have been in business since at least the year 2000 and which have a five star rating.” The results of a query, as stated, is transmitted to the cell phone 20 as an “item set” which appears on screen and is thus made available to the user from which to make a selection. If no selection is made, no billing occurs.

Appropriate query results are returned from the database 12 with corresponding phone numbers, location information, quality grades and other pertinent information as desired by the user. It should be understood that the data transmission process described above is symmetrical. The SMS transmission from the server 10 is removed from the cell phone mailbox by the client application.

As shown in FIG. 1, preferably, a large number of cell phones 20 are in communication with the server 10 at any one time. Each of these cell phones 20, to initiate the present method, open a resident application software program, a part of the cell phone's operating program, which brings up the directory listing of heading subjects such as exemplified above. Next, the user scrolls to, and selects, a subject heading of choice and continues to scroll to select a sub-heading and a sub-sub-heading as necessary to home onto a final subject as shown in FIG. 2 where “Law Enforcement” is highlighted. As an example, referring to FIG. 2, one might select “Community” and then “Emergency Services” and finally “Law Enforcement” and, by pressing the “Talk” button on the cell phone 20 a data transfer connection is immediately established between the cell phone 20 and the server 10.

The user may be calling for assistance within the user's current location, or for assistance at an alternate location. In either case, a use location must be specified and this may be accomplished automatically if the cell phone 20 is GPS enabled, or the user may override the GPS or other default location and enter a zip code or a city or town name either verbally with word recognition enablement, as is well known in the art. The selected subject heading is also communicated to the server. The server 10 reacts by conducting a database query on the subject and then transmitting to the cell phone 20, a list of the names, addresses and phone numbers of the places corresponding to the use location and the selected subject heading and these are displayed on the cell phone display except the phone number is not displayed at this time. Scrolling may be necessary again in order to review all of the possible choices provided by the server 10 especially when the factors of address location, quality grade, years in business or other facts are included on the screen 24.

Next the user selects one of the alternatives on his/her screen 24 and this initiates three events; first, the phone number of the selection appears on screen 24, second the connection to the server 10 is extinguished after data transfer of the name of the place selected. to the server 10, and third the phone of the selected place is called. When server 10 receives the information that a selection was made by the cell phone 20, billing to the selected place 30 is initiated through the billing service 40. Even if phone connection to the selected place 30 is not made due to a busy number, faulty connection or otherwise, billing is still considered to be valid in that the subject method has fulfilled an important marketing benefit and the telephone number of chosen place 30 is now resident in the requesters cell phone, if not other demographic information thereof.

Preferably, therefore, the phone number of each place 30 requested by the user is stored in a phone number directory of the cell phone 20. It is stressed, and important to reiterate, that the identification of a use location may be accomplished by transmitting a postal zip code, the name of a city or other location vicinity, or by other information so as to narrow the scope of the places included in the choice set. If a subject/geographical limitation by user returns a over-sized number of places 30, a request to limit the subject or the geo-area will be made by the server 10 prior to proceding.

Alternately, when the cell phone 20 is GPS enabled, the current location of the user is automatically transferred from the phone 20 to the server 10 and unless another option is selected by the user the current location of the user forms the basis for selection of places 30.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method of providing directory services to a user of a wireless device, the method comprising the steps of:
a) establishing a hierarchical directory of industrial and commercial subject headings as a first digital database stored within a first non-volatile memory device in a cell phone accessible to a public cell phone network and thereby to the Internet;
b) establishing a list of industrial and commercial places as a second digital database stored within a second non-volatile memory device in communication with an Internet accessible server, said list including a name, an address and a telephone number for each of the places;
c) opening an application software program stored in the cell phone;
d) scrolling to, and selecting, a subject heading in the directory of industrial and commercial subject headings in the first digital database;
e) establishing a cell phone communication connection between the cell phone and the server;
f) transmitting the selected subject heading and a use location to the server;
g) running a query in the list of industrial and commercial places in accordance with the selected subject heading and use location and then transmitting to the cell phone, and then displaying on the cell phone, a resultant item set generated by the query;
h) selecting and then transmitting to the server, a selected one of the item set;
i) billing the selected one of the item set and then presenting to the cell phone screen and dialing a phone number for the selected one of the item set.

2. The method of claim 1 comprising the further step of storing the phone number in a phone number directory of the cell phone.

3. The method of claim 1 wherein the identification of the use location includes the step of transmitting a postal zip code from the cell phone to the server.

4. The method of claim 1 wherein the identification of the use location includes the step of transmitting a city name from the cell phone to the server.

5. The method of claim 1 wherein the identification of the use location includes the step of transmitting a current GPS location of the cell phone to the server.

6. The method of claim 1 further comprising the step of transmitting to the cell phone a quality rating for each one of the places.

7. The method of claim 1 wherein the query is limited by subject.

8. The method of claim 1 wherein the query is limited by geographical coordinates.

9. The method of claim 1 wherein the query is limited by geographical description.

10. The method of claim 1 wherein the query is limited by zip code.

11. The method of claim 1 wherein the query is limited by county.

12. The method of claim 1 wherein the query is limited by State.

13. The method of claim 1 wherein the query is limited by country.

14. The method of claim 1 wherein the query is limited by quality rating.

15. The method of claim 1 wherein the query is limited date of establishment.

16. The method of claim 1 wherein the query is limited by maximum number of selections.

17. The method of claim 1 wherein the query is limited by geographical area.

18. The method of claim 1 wherein the query is limited by ethnic orientation.

19. The method of claim 1 wherein the query is limited by a chosen radial distance from an current location of the cell phone.
